(19) United States
(12) Patent Application Publication
(10) Pub. No.: US 2018/0091255 A1
(43) Pub. Date: Mar. 29, 2018

(54) COMMUNICATION STATE DETERMINATION METHOD AND COMMUNICATION STATE DETERMINATION DEVICE

(71) Applicant: Honda Motor Co., Ltd., Tokyo (JP)

(72) Inventor: Katsunori Miyazawa, Tochigi (JP)

(21) Appl. No.: 15/685,173

(22) Filed: Aug. 24, 2017

(30) Foreign Application Priority Data
Sep. 28, 2016 (JP) 2016-190455

(51) Int. Cl. H04L 1/00; H04L 12/26; H04L 29/06; H04L 12/801

(52) U.S. Cl. CPC H04L 1/0001; H04L 47/10; H04L 65/602; H04L 43/0864

(57) ABSTRACT

Provided is a technique enabling even a person having no advanced expert knowledge on communication to easily confirm consistency between communication events among specified devices and specified specifications. A simple communication log is generated by integrating duplicated events in a communication log (specified communication log LOG1) between specified devices 21-i (i=1, 2, - - - N) and 22 extracted from all communication logs between a plurality of devices in a communication environment in accordance with the specified specifications PTC and the simple communication log is output through an output device 14. Thereby, a worker is able to compare the output simple communication log LOG2 with the specified specifications PTC and to confirm consistency between both of them more easily.

### BACKGROUND OF THE INVENTION

### Field of the Invention

The present invention relates to a technique enabling even a person having no advanced expert knowledge on communication to easily confirm consistency between communication events among specified devices and specified specifications.

### Description of the Related Art

A technique of acquiring spatial wireless communication packets and browsing the contents of telegraphic messages thereof is generally hacking and is performed only by some specialists. Accordingly, this kind of techniques have developed in information and communication fields and in recent years there are some kinds of Linux®-based software are present, though many of them are GUI-based tools. Among them, there is freeware named “Wireshark®” as a typical example of software which operates on Windows® thereby being in widespread use and can be operated via the GUI. This tool is intended to perform detailed (in all layers) troubleshooting and analysis on a network by collecting actual packets flowing through the Ethernet. Since a large number of packets are collected if packets are collected only, intended packets are narrowed down by using a filter function (arbitrary narrowing-down is enabled by combining filter expressions) when Wireshark® is practically used, by which only target packets can be extracted to be browsed. In addition, some functions are provided such as a function of listing the contents of respective telegraphic messages for the packets obtained by narrowing-down and a function of visualizing the situation in which packets for each terminal are exchanged.

With the development of a technique using a wireless network between facilities in a production line in recent years as a background, there has been occurred a demand for confirming what kind of wireless communication is actually performed in order to analyze the contents in the case of a trouble of a wireless network between facilities (refer to Japanese Patent Application laid-Open No. 2012-234273, Japanese Patent No. 4868204, and Japanese Pat Application laid-Open No. 2009-147646, for example).

The conventional tools are, however, based on the premise that network specialists use the tools. Therefore, it is difficult to master the provided tools in the absence of knowledge of various network protocols and therefore, in fact, it has been impossible for a field personnel of the production line to analyze the content of a trouble in detail.

Any tool on the market is mainly intended to perform detailed (in all layers) troubleshooting and analysis on a network by collecting actual packets flowing through a wireless space or the Ethernet. Since the acquired packet amount is enormous, this kind of tools include a function of searching for or filtering packets depending on the intended use and it is then necessary to understand and use the syntaxes of the functions.

In addition, even if the packet contents are understood by using these functions, it is necessary to set messages against specifications in order to confirm that the messages having correct contents are transmitted in a correct order, though it takes a lot of time to analyze the contents only in confirming the content of each message. For example, work cost is correspondingly required to determine the consistency between the communication specifications (communication protocol) illustrated on the left side of FIG. 5 and an enormous amount of communication logs illustrated on the right side of FIG. 5.

### SUMMARY OF THE INVENTION

Therefore, it is an object of the present invention to provide a technique enabling even a person having no advanced expert knowledge on communication to easily confirm consistency between communication events among specified devices and specified specifications.

According to an aspect of the present invention, there is provided a communication state determination method for determining a communication state between a plurality of specified devices in an environment in which the plurality of devices communicate in accordance with specified specifications, the method comprising: a step of acquiring all communication logs between the plurality of devices and storing the communication logs in a storage device; a step of extracting a communication log between the plurality of specified devices, as a specified communication log, from all the communication logs between the plurality of devices stored in the storage device; a step of generating a simple communication log by integrating duplicated communication events included in the specified communication log; and a step of causing an output device to output the simple communication log or both of the specified specifications and the simple communication log.

In the communication state determination method of the present invention, preferably the output device is caused to output different parts between the specified specifications and the simple communication log in a manner different from a manner of same parts.

In the communication state determination method of the present invention, preferably the output device is caused to output a number of times the integrated communication events are duplicated in the specified communication log.

According to the communication state determination method of the present invention, duplicated events are integrated, unified, put together; or consolidated in a communication log between specified devices (specified communication log) extracted from all communication logs between a plurality of devices in a communication environment in accordance with specified specifications, by which a simple communication log is generated and output through an output device. Thereby, a worker is able to easily perform the works of comparing the output simple communication log with the specified specifications and then confirming consistency between both of them. Accordingly, even if the worker has no advanced expert knowledge (as long as the worker has a basic knowledge on communication), he/she is able to grasp communication events (confirm the feasibility) and the number of man-hours for dealing with a failure can be reduced. It is particularly useful in the case of installing and operating facilities having a communication function in a place where no advanced specialist on communication is present.

### BRIEF DESCRIPTION OF THE DRAWINGS

FIG. 1 is an illustration of specified devices to which a communication state determination method of the present invention is to be applied;

FIG. 2 is an explanatory diagram of a procedure of the communication state determination method as an embodiment of the present invention;

FIG. 3 is an explanatory diagram of simplification processing of a specified communication log;

FIG. 4 is an explanatory diagram of the specified communication log and a simple communication log; and

FIG. 5 is an explanatory diagram of a conventional communication state determination method.

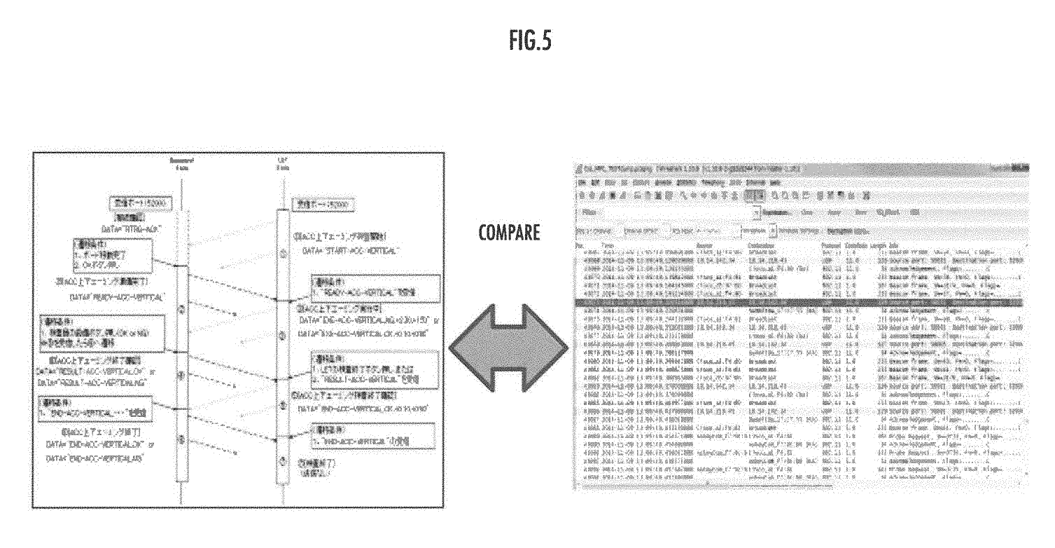

### DESCRIPTION OF THE PREFERRED EMBODIMENTS

(Communication State Determination Device)

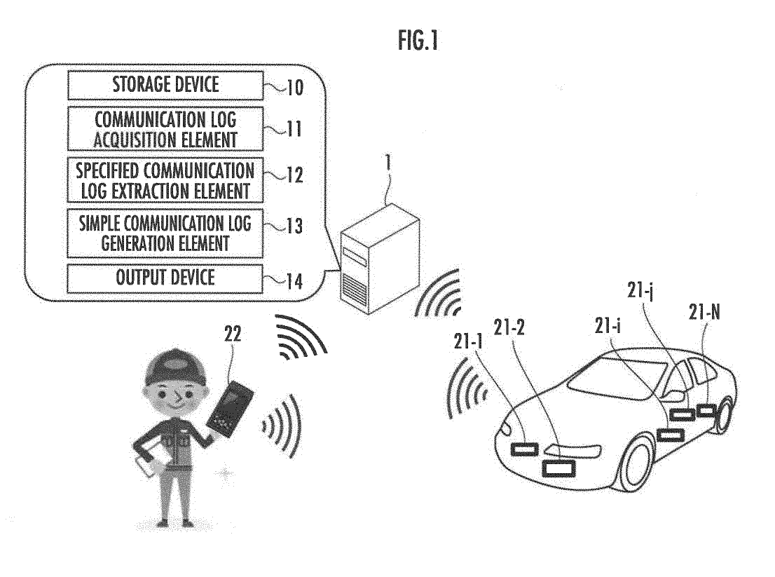

A communication state determination method as one embodiment of the present invention is used to determine the communication state between specified devices among a plurality of devices in an environment in which the plurality of devices communicate with each other according to specified specifications (specified communication protocol). The method is implemented by a server 1 (a communication state determination device) having a wireless communication function illustrated in FIG. 1, for example. For example, a vehicle inspection device 22 corresponds to the “specified device” where the vehicle inspection device 22 is used to inspect a plurality of ECUs 21-1, 21-2, - - - 21-N (electronic control units) mounted on a vehicle and wirelessly communicating with each other and the operating states of the vehicle including the operating states of the ECUs 21-1, 21-2, - - - 21-N. The server 1 includes a storage device 10, a communication log acquisition element 11 (a first processing element), a specified communication log extraction element 12 (a second processing element), a simple communication log generation element 13 (a third processing element), and an output device 14. The elements 11 to 13 are each composed of a processor (a single-core processor, a multi-core processor, or the like) constituting the server 1. The functional element for adjusting the output mode of the output device 14 corresponds to “fourth processing element.” The communication modes between the respective plurality of ECUs 21-i (i=1, 2, - - - N) and the vehicle inspection device 22 are basically different from each other.

(Communication State Determination Method)

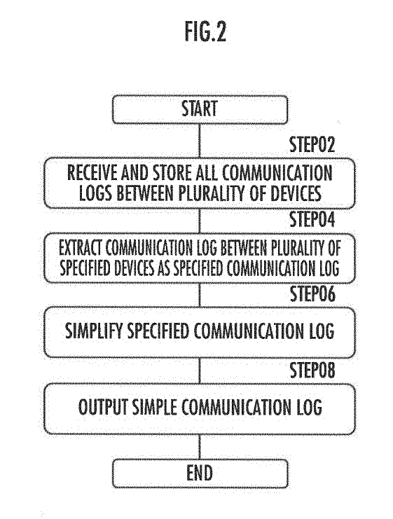

According to the server 1 having the above configuration, first, the communication log acquisition element 11 acquires (or receives) all communication logs between a plurality of devices in a communication environment and then the storage device 10 stores the communication logs (STEP 02 of FIG. 2). The storage device 10 may be composed of a database server separate from the server 1 or may be composed of a storage device of an arbitrary device including the specified devices 21-i and 22 among the plurality of devices.

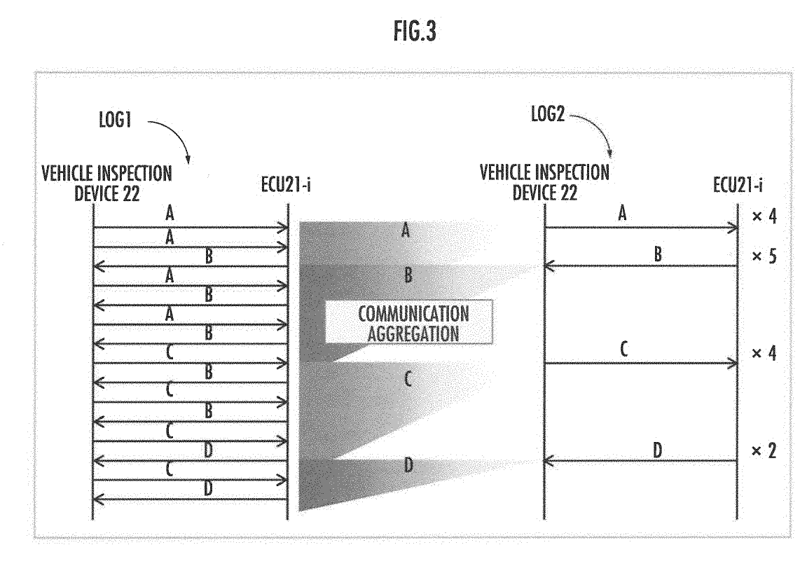

The specified communication log extraction element 12 extracts a communication log between one or more in-vehicle ECUs 21-i and the vehicle inspection device 22, as a specified communication log, from all communication logs between the plurality of devices stored in the storage device 10 (STEP 04 of FIG. 2). Thereby, for example, a specified communication log LOG1 illustrated on the left side of FIG. 3 is extracted. According to the specified communication log LOG1, the time series of the communication events are expressed as illustrated in TABLE 1. The transmission from the vehicle inspection device 22 to the ECU 21-i is represented by “→(right arrow)” and the transmission from the ECU 21-i to the vehicle inspection device 22 is represented by “←(left arrow)” (the same shall apply hereinafter).

TABLE 1

| communication | communication | communication | communication | communication |
|---|---|---|---|---|
| events | of message A | of message B | of message C | of message D |
| X1 | → | | | |
| X2 | → | | | |
| X3 | | ← | | |
| X4 | → | | | |
| X5 | | ← | | |
| X6 | → | | | |
| X7 | | ← | | |
| X8 | | | → | |
| X9 | | ← | | |
| X10 | | | → | |
| X11 | | ← | | |
| X12 | | | → | |
| X13 | | | | ← |
| X14 | | | → | |
| X15 | | | | ← |

The simple communication log generation element 13 generates a simple communication log by integrating duplicated communication events included in the specified communication log (STEP 06 of FIG. 2). In the example illustrated on the left side of FIG. 3 and TABLE 1, communication events X1, X2, X4, and X6 are each “communication of message A” and are duplicated. Communication events X3, X8, X7, X9, and X11 are each “communication of message B” and are duplicated. Communication events X8, X10, X12, and X14 are each “communication of message C” and are duplicated. Communication events X13 and X15 are each “communication of message D” and are duplicated. These duplications of communication events (message transmission) are frequently seen from the viewpoint of improving communication toughness. Accordingly, a simple communication log LOG2 as illustrated on the right side of FIG. 3 is generated by integrating the duplicated communication events. According to the simple communication log LOG2, the time series of communication events are expressed as illustrated in TABLE 2. The number in parentheses represents the number of times the communication is duplicated.

TABLE 2

| communication | communication | communication | communication | communication |
|---|---|---|---|---|
| events | of message A | of message B | of message C | of message D |
| Y1 | →(4) | | | |
| Y2 | | ←(5) | | |
| Y3 | | | →(4) | |
| Y4 | | | | ←(2) |

In the example illustrated on the right side of FIG. 3 and TABLE 2, the communication events X1, X2, X4, and X6 duplicated in the specified communication log are integrated into a communication event Y1 (communication of message A). The duplicated communication events X3, X5, X7, X9, and X11 are integrated into a communication event Y2 (communication of message B). The duplicated communication events X8, X10, X12, and X14 are integrated into a communication event Y3 (communication of message C). The duplicated communication events X13 and X15 are integrated into a communication event Y4 (communication of message D). The chronological order of the communication events Y1 to Y4 in the simple communication log LOG2 is defined according to the chronological order in which the corresponding communication events appear first in the specified communication log LOG1. In addition, the chronological order of the communication events Y1 to Y4 in the simple communication log LOG2 may be defined according to the chronological order in which the corresponding communication events appear last in the specified communication log LOG1 or according to the chronological order in which the corresponding communication events appear in the n-th place (for example, n=2) in the specified communication log LOG1.

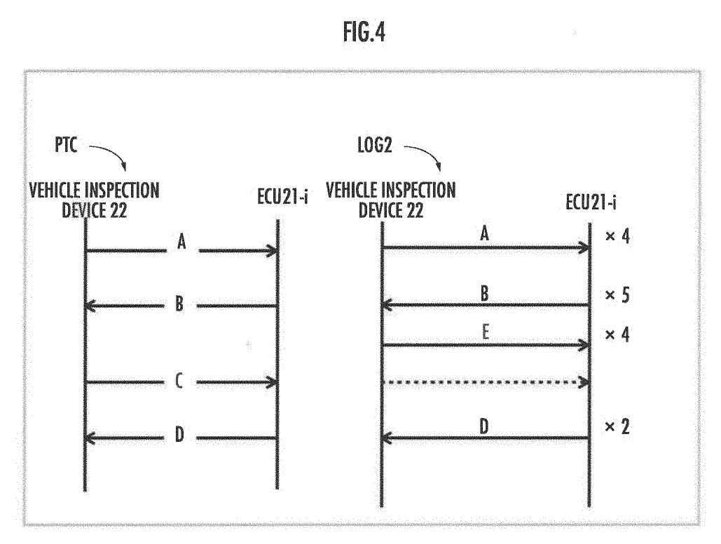

Thereafter, the server 1 outputs the simple communication log through the output device 14 (STEP 08 of FIG. 2). The output device 14 may be composed of an output device of an arbitrary device such as a display device constituting the vehicle inspection device 22, in addition to or instead of the output device constituting the server 1. Thereby, for example, as illustrated in FIG. 4, the simple communication log LOG2 is displayed on the output device 14 together with the specified specifications PTC. In the example illustrated in FIG. 4, the time series of the communication events in the specified specifications PTC are expressed as illustrated in TABLE 3, while the time series of the communication events in the simple communication log LOG2 are expressed as illustrated in TABLE 4.

TABLE 3

| communication | communication | communication | communication | communication |
|---|---|---|---|---|
| events | of message A | of message B | of message C | of message D |
| Z1 | → | | | |
| Z2 | | ← | | |
| Z3 | | | → | |
| Z4 | | | | ← |

TABLE 4

| communication | communication | communication | communication | communication |
|---|---|---|---|---|
| events | of message A | of message B | of message C | of message D |
| Y1 | →(4) | | | |
| Y2 | | ←(5) | | |
| Y5 | | | →(4) | |
| Y4 | | | | ←(2) |

As illustrating on the right side of FIG. 4, the number of times each of the communication event Y1. (communication of message A), the communication event Y2 (communication of message B), the communication event Y5 (communication of message E), and the communication event Y4 (communication of message D) is duplicated is displayed together with the simple communication log LOG2 (see the number in parentheses on TABLE 4). Moreover, the specified specifications PTC and the simple communication log LOG2 are the same in the communication events that appear chronologically first, second, and fourth, while they are different in the communication event that appears chronologically third. Therefore, in the simple communication log LOG2 (or each of the simple communication log LOG2 and the specified specifications PTC), the different part is displayed in a mode in which at least one of the plurality of elements affecting the visibility of the worker, such as color, font, and size, is different from that of the same part.

(Operational Advantage of the Invention)

According to the communication state determination method of the present invention, a simple communication log is generated and output through the output device 14 by integrating the duplicated events in the communication log (the specified communication log LOG1) between the specified devices 21-i and 22 extracted from all communication logs between the plurality of devices in the communication environment in accordance with the specified specifications PTC (see STEPS 02 to 08 of FIG. 2 and FIG. 4). Thereby, a worker is able to compare the output simple communication log LOG2 with the specified specifications PTC and to confirm the consistency between both more easily (see TABLE 3, TABLE 4, and FIG. 4). For example, in the example illustrated in FIG. 4, the worker is able to easily confirm that the specified specifications PTC and the simple communication log LOG2 are the same as each other in the communication events that appear chronologically first, second, and fourth while they are different from each other in the communication event that appears chronologically third.

### Other Embodiments of the Present Invention

Although message communication is defined as a communication event in the above embodiment, transmitting and receiving a plurality of different messages in accordance with a specified chronological order, such as receiving the message B after transmitting the message A, may be defined together as one communication event.

### DESCRIPTION OF THE REFERENCE NUMERALS

1 Server
10 Storage device
11 Communication log acquisition element
12 Specified communication log extraction element
13 Simple communication log generation element
17 Output device
21-i ECU (Specified device)
22 Vehicle inspection device (Specified device)
LOG1 Specified communication log
LOG2 Simple communication log
PTC Specified specifications (Specified communication protocol)

What is claimed is:

1. A communication state determination method for determining a communication state between a plurality of specified devices in an environment in which the plurality of devices communicate in accordance with specified specifications, the method comprising:
a step of acquiring all communication logs between the plurality of devices and storing the communication logs in a storage device;
a step of extracting a communication log between the plurality of specified devices, as a specified communication log, from all the communication logs between the plurality of devices stored in the storage device;
a step of generating a simple communication log by integrating duplicated communication events in the specified communication log; and
a step of causing an output device to output the simple communication log or both of the specified specifications and the simple communication log.

2. The communication state determination method according to claim 1, wherein the output device is caused to output different parts between the specified specifications and the simple communication log in a manner different from a manner of same parts.

3. The communication state determination method according to claim 1, wherein the output device is caused to output a number of times the integrated communication events are duplicated in the specified communication log.

4. A communication state determination device for determining a communication state between a plurality of specified devices in an environment in which the plurality of devices communicate in accordance with specified specifications, the device comprising a processor, wherein the processor includes:
a first processing element which acquires all communication logs between the plurality of devices and stores the communication logs in a storage device;
a second processing element which extracts a communication log between the plurality of specified devices, as a specified communication log, from all the communication logs between the plurality of devices stored in the storage device;
a third processing element which generates a simple communication log by integrating duplicated communication events in the specified communication log; and
a fourth processing element which causes an output device to output the simple communication log or both of the specified specifications and the simple communication log.

5. The communication state determination device according to claim 4, wherein the fourth processing element causes the output device to output different parts between the specified specifications and the simple communication log in a manner different from a manner of same parts.

6. The communication state determination device according to claim 4, wherein the fourth processing element causes the output device to output a number of times the integrated communication events are duplicated in the specified communication log.
